(19) United States
(12) Patent Application Publication
(10) Pub. No.: US 2025/0200914 A1
(43) Pub. Date: Jun. 19, 2025

(54) INFORMATION PROCESSING APPARATUS, INFORMATION PROCESSING METHOD, AND NON-TRANSITORY COMPUTER READABLE MEDIUM FOR SERVICE THAT ENABLES COMMUNICATION IN UNREAL SPACE

(71) Applicant: CANON KABUSHIKI KAISHA, Tokyo (JP)

(72) Inventor: TOSHIYUKI TAKAGI, Kanagawa (JP)

(21) Appl. No.: 19/069,963

(22) Filed: Mar. 4, 2025

Related U.S. Application Data
(63) Continuation of application No. PCT/JP2023/021542, filed on Jun. 9, 2023.

(30) Foreign Application Priority Data
Sep. 14, 2022 (JP) 2022-145806

(51) Int. Cl. G06T 19/00; G06T 19/20

(52) U.S. Cl. CPC G06T 19/006; G06T 19/20; G06T 2219/024; G06T 2219/2004

(57) ABSTRACT

An information processing apparatus according to the present invention executes determination processing of determining arrangement of a plurality of avatars in an unreal space respectively corresponding to a plurality of participants of a service that enables communication in the unreal space, execute acquisition processing of acquiring information on a positional relationship of a first participant and a second participant in a real space in a case where it is detected that the second participant in the service exists near the first participant who newly participates in the service, in the real space, and execute control processing of performing control to perform predetermined notification to the first participant based on the information in a case where the first participant gives instruction of movement of the avatar of the first participant, wherein, in the determination processing, arrangement of the plurality of avatars is determined based on the information.

### CROSS-REFERENCE TO RELATED APPLICATIONS

This application is a Continuation of International Patent Application No. PCT/JP2023/021542, filed Jun. 9, 2023, which claims the benefit of Japanese Patent Application No. 2022-145806, filed Sep. 14, 2022, all of which are hereby incorporated by reference herein in their entirety.

### BACKGROUND OF THE INVENTION

### Field of the Invention

The present invention relates to an information processing apparatus, an information processing method, and a non-transitory computer readable medium and particularly relates to a service that enables communication in an unreal space.

### Background Art

Systems for online conferences in an unreal space such as a virtual reality space (VR space) or a mixed reality space (MR space) have been suggested. In such a system, participants of an online conference are represented by virtual avatars. For example, the participant wears a head mounted display (HMD) on the head. In the HMD, a conference room that is a three-dimensional unreal space is displayed, and avatars of other participants are displayed in the conference room. Then, the voice of the other participant is output from the speaker of the HMD as if the voice is heard from the direction in which the avatar of the other participant is present. As a result, the participant can experience as if the participant actually meets with the other participants.

PTL 1 discloses a technique for displaying an HMD of a user sitting on a seat of a vehicle so that an avatar of another user at a place distant from the vehicle is sitting on another seat of the vehicle.

PTL 2 discloses a technique for determining arrangement of a plurality of avatars (a plurality of avatars respectively corresponding to a plurality of users) in a virtual reality space based on a positional relationship among a plurality of users in the real space.

However, in a system for an online conference in an unreal space in the related art, a positional relationship of a plurality of participants who are nearby in the real space may be different from a positional relationship of a plurality of avatars (a plurality of avatars respectively corresponding to the plurality of participants) in the unreal space. In this case, the direction in which the voices of the other participants are heard through the speaker of the HMD is different from the direction in which the voices of the other participants are heard without the speaker of the HMD. Therefore, the participants feel uncomfortable and the immersive feeling of the participants is impaired.

Such a problem is not limited to a system for an online conference in an unreal space and may occur in various services that enable communication in the unreal space. For example, in the technique disclosed in PTL 1, avatars of two users arranged side by side in a real space may be arranged front and back in a vehicle. In the technique disclosed in PTL 2, a predetermined fixed positional relationship is considered as the positional relationship among the plurality of users in the real space, but the above problem occurs in a case where the positional relationship among the plurality of users in the real space is not predetermined.

The present invention provides a technology capable of suitably determining the arrangement of each avatar in an unreal space even in a case where a positional relationship of a plurality of participants in the real space is not predetermined in a service that enables communication in the unreal space.

### CITATION LIST

### Patent Literature

PTL 1 JP 2021-149607 A
PTL 2 WO 2018/198777 A1

### SUMMARY OF THE INVENTION

The present invention in its first aspect provides an information processing apparatus including one or more processors and/or circuitry configured to execute determination processing of determining arrangement of a plurality of avatars in an unreal space respectively corresponding to a plurality of participants of a service that enables communication in the unreal space, execute acquisition processing of acquiring information on a positional relationship of a first participant and a second participant in a real space in a case where it is detected that the second participant in the service exists near the first participant who newly participates in the service, in the real space, and execute control processing of performing control to perform predetermined notification to the first participant based on the information in a case where the first participant gives instruction of movement of the avatar of the first participant, wherein, in the determination processing, arrangement of the plurality of avatars is determined based on the information.

The present invention in its second aspect provides an information processing method including determining arrangement of a plurality of avatars in an unreal space respectively corresponding to a plurality of participants of a service that enables communication in the unreal space, acquiring information on a positional relationship of a first participant and a second participant in a real space in a case where it is detected that the second participant in the service exists near the first participant who newly participates in the service, in the real space, and performing control to perform predetermined notification to the first participant based on the information in a case where the first participant gives instruction of movement of the avatar of the first participant, wherein arrangement of the plurality of avatars is determined based on the information.

The present invention in its third aspect provides a non-transitory computer readable medium that stores a program, wherein the program causes a computer to execute an information processing method including determining arrangement of a plurality of avatars in an unreal space respectively corresponding to a plurality of participants of a service that enables communication in the unreal space, acquiring information on a positional relationship of a first participant and a second participant in a real space in a case where it is detected that the second participant in the service exists near the first participant who newly participates in the service, in the real space, and performing control to perform predetermined notification to the first participant based on the information in a case where the first participant gives instruction of movement of the avatar of the first participant, wherein arrangement of the plurality of avatars is determined based on the information.

Further features of the present invention will become apparent from the following description of exemplary embodiments with reference to the attached drawings.

### BRIEF DESCRIPTION OF THE DRAWINGS

FIG. 1 is a diagram illustrating a configuration of an online conference system according to first to third embodiments;

FIG. 2 is a diagram illustrating a configuration of an HMD system according to the first to third embodiments;

FIG. 3 is a diagram illustrating a configuration of a server device according to the first to third embodiments;

FIG. 4A is a diagram illustrating arrangement of the HMD systems according to the first embodiment, FIG. 4B is a diagram illustrating arrangement of avatars, and FIG. 4C is a diagram illustrating arrangement of avatars according to the first embodiment;

FIG. 5 is a diagram illustrating a processing flow of the online conference system according to the first embodiment;

FIG. 6 is a diagram illustrating a processing flow of the HMD system according to the first embodiment;

FIG. 7 is a diagram illustrating a processing flow of the server device according to the first embodiment;

FIG. 8A is a diagram illustrating arrangement of the HMD systems according to the second embodiment, FIG. 8B is a diagram illustrating arrangement of avatars according to the second embodiment, and FIG. 8C is a diagram illustrating a warning screen according to the second embodiment;

FIG. 9 is a diagram illustrating a processing flow of the online conference system according to the second embodiment;

FIG. 10 is a diagram illustrating a processing flow of the HMD system according to the second embodiment;

FIG. 11 is a diagram illustrating a processing flow of the server device according to the second embodiment;

FIGS. 12A, 12C, and 12D are diagrams illustrating arrangement of the avatars according to the third embodiment, and FIG. 12B is a diagram illustrating arrangement of the HMD systems according to the third embodiment; and

FIG. 13 is a diagram illustrating a processing flow of the server device according to the third embodiment.

### DESCRIPTION OF THE EMBODIMENTS

In the description below, embodiments of the present invention are described based on the accompanying drawings. Note that the embodiments described below are merely examples, and a configuration obtained by appropriately modifying or changing configurations of the embodiments within the scope of the gist of the present invention is in also included in the present invention. A configuration obtained by appropriately combining the configurations of the embodiments is also included in the present invention.

### First Embodiment

### Configuration of System

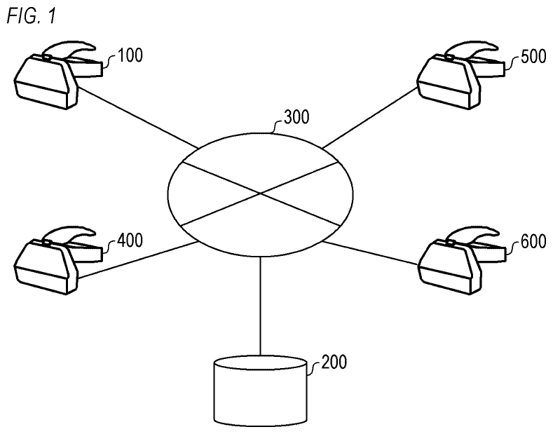

A first embodiment of the present invention is described. FIG. 1 is a schematic diagram illustrating an example of an overall configuration of a system according to the first embodiment. The system in FIG. 1 is a system for communication in an unreal space, such as a virtual reality space (VR space) or a mixed reality space (MR space), for example, a system for an online conference in an unreal space (online meeting system). The VR space is a three-dimensional space (world) made of computer graphics (CG). The MR space is a three-dimensional space similar to the real space. Virtual objects (for example, avatars) may be arranged in the MR space, but the virtual objects cannot be arranged in the real space. That is, when the real space is viewed without using the display devices that display the virtual object, the real space does not become the MR space, and when the real space is viewed using the display device that displays the virtual object, the real space becomes the MR space. The MR space can also be regarded as an augmented reality (AR) space. The avatar is a character (user character) that is the other self of the user (user of the above system) in an unreal space and is made of CG.

The system in FIG. 1 includes HMD systems 100, 400, 500, and 600, a server device 200, and a network 300.

Each of the HMD systems 100, 400, 500, and 600 is used by participants (for example, participants of an online conference in an unreal space) of a service that enables communication in an unreal space. Each of the HMD systems 100, 400, 500, and 600 includes a head mounted display (HMD) that is a head mounted display device and a client device that is an information processing apparatus. The four HMD systems 100, 400, 500, and 600 correspond to four participants, respectively. Each of the HMD systems 100, 400, 500, and 600 is communicably connected to the server device 200 via the network 300.

Note that, in the first embodiment, an example in which the client device and the HMD are separate devices is described, but the client device and the HMD may be integrally configured. In addition, the number of participants is not particularly limited, and may be more or less than four. The connection between the HMD systems 100, 400, 500, and 600 and the server device 200 via the network 300 may be wired connection or wireless connection.

The server device 200 is a server device (information processing apparatus) that provides a service that enables communication in an unreal space. Note that the number of server devices is not particularly limited, and the service may be provided by a plurality of server devices performing processing in parallel.

In the first embodiment, an example of an online conference in an unreal space is described. When the unreal space is the VR space, a video in which avatars are arranged in a CG conference room is displayed in each of the HMD systems 100, 400, 500, and 600. When the unreal space is the MR space, avatars are displayed as if the avatars are arranged in a real conference room in each of the HMD systems 100, 400, 500, and 600. When the unreal space is the MR space, in each of the HMD systems 100, 400, 500, and 600, the HMD may function as a video see-through HMD or may function as an optical see-through HMD. In the first embodiment, an example in which the HMD functions as a video see-through HMD is described. When the unreal space is an MR space, the participant can see other participants (real participants who are not avatars) who are near the participant in the real space. In the participant's HMD system (HMD), avatars of other participants who are near the participant in the real space are not displayed, and only avatars of other participants who are at a place away from the participant in the real space are displayed.

### Configuration of HMD System

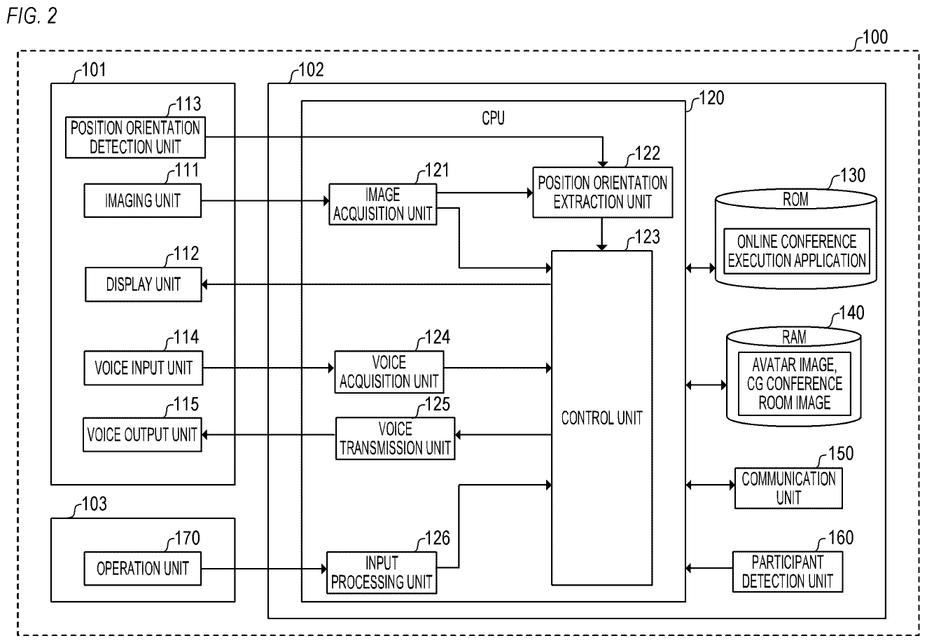

FIG. 2 is a block diagram illustrating a configuration of the HMD system 100. The HMD system 100 includes an HMD 101, a client device 102, and an input device 103. The HMD 101 and the client device 102 are communicably connected by wire or wirelessly, and the client device 102 and the input device 103 are communicably connected by wire or wirelessly. The HMD systems 400, 500, and 600 have configurations similar to that of the HMD system 100. Note that, in the first embodiment, an example in which the HMD 101, the client device 102, and the input device 103 are separate devices is described, but at least two of the three devices may be integrally configured.

### Configuration of HMD

The HMD 101 includes an imaging unit 111, a display unit 112, a position orientation detection unit 113, a voice input unit 114, and a voice output unit 115.

The imaging unit 111 images the outside world (real space). For example, the imaging unit 111 includes an image sensor that converts light into an electrical signal and an objective optical system that guides external light to the image sensor.

The display unit 112 displays a video generated by the client device 102 (a video corresponding to a field of vision of the user wearing the HMD 101). Note that the HMD 101 may include a right-eye display unit and a left-eye display unit. Then, stereoscopic images (a right-eye image and a left-eye image) that can be stereoscopically viewed may be displayed by the two display units.

The position orientation detection unit 113 detects the position orientation of the HMD 101 (the user wearing the HMD 101) in the real space. For example, the position orientation detection unit 113 includes various sensors such as an acceleration sensor, an angular velocity sensor, a geomagnetic sensor, and a GPS sensor. The detection result of the position orientation detection unit 113 is used for controlling the display by the display unit 112 and controlling the orientation of the avatar corresponding to the user (the user wearing the HMD 101). For example, in the unreal space, a portion displayed on the display unit 112 is changed according to a change in the position orientation of the user. As a result, it is possible to give the user a feeling as if the user is in an unreal space. Furthermore, the orientation of the avatar corresponding to the user is changed according to the change in the orientation of the user. This enables communication using the orientation.

The voice input unit 114 is a microphone that acquires a voice. The voice input unit 114 may be an input terminal to which a voice input device such as a microphone is connected.

The voice output unit 115 is a speaker that outputs voice. The voice output unit 115 may be an output terminal to which a voice output device such as a speaker, a headphone, or an earphone is connected.

Note that a tablet terminal or another display device may be used instead of the HMD 101. Any display device may be used as long as the display device is a (portable) display device that can display a video corresponding to the field of vision of the user.

### Configuration of Input Device

The input device 103 includes an operation unit 170. The operation unit 170 receives a user operation (operation by the user) and outputs an operation signal corresponding to the performed user operation. In response to a user operation (operation signal), for example, an avatar corresponding to the user is controlled to perform a specific action (gesture or movement). The user can also give instruction to switch the unreal space between the VR space and the MR space. The input device 103 is, for example, a joystick that outputs an operation signal corresponding to the direction and magnitude of the tilt of the lever. Note that the input device 103 is not limited to the joystick and may be, for example, a mouse, a keyboard, or a game pad.

### Configuration of Client Device

The client device 102 includes a CPU 120, a ROM 130, a RAM 140, a communication unit 150, and a participant detection unit 160. An image acquisition unit 121, a position orientation extraction unit 122, a control unit 123, a voice acquisition unit 124, a voice transmission unit 125, and an input processing unit 126 are implemented by the CPU 120. The client device 102 is an information processing apparatus having an excellent arithmetic processing function and a graphic drawing function and is, for example, a smartphone, a personal computer, or a workstation.

The CPU 120 performs various types of processes (various types of control) of the client device 102. The ROM 130 is a nonvolatile memory. The ROM 130 stores programs of an operating system (OS), programs of various types of applications, and other information. For example, the ROM 130 stores a program of an application (online conference execution application) for performing an online conference. The RAM 140 is a volatile memory and is used as, for example, a work area of the CPU 120.

The image acquisition unit 121 acquires a real image (an image obtained by capturing a real space) obtained by the imaging unit 111.

The position orientation extraction unit 122 acquires the position orientation (position orientation information) detected by the position orientation detection unit 113. The position orientation extraction unit 122 may detect markers arranged in the real space from a real image acquired by the image acquisition unit 121. Then, the position orientation extraction unit 122 may detect the position orientation of the HMD 101 (user) in the real space based on the detection result of the markers.

The control unit 123 executes an online conference execution application (a program of the online conference execution application) stored in the ROM 130 and executes various processes for performing the online conference. For example, the control unit 123 transmits the position orientation information acquired by the position orientation extraction unit 122 to the server device 200 in order to share the position orientation information with other participants of the online conference. In order to perform the online conference, the control unit 123 receives the avatar images (three-dimensional image of the avatars) of the other participants and the CG conference room image (three-dimensional image of the CG conference room) from the server device 200 and stores the images in the RAM 140. Furthermore, the control unit 123 receives the position orientation information of the other avatars (the other participants) and the seat information of each avatar from the server device 200. The control unit 123 controls the communication unit 150 to communicate with the server device 200.

When the unreal space is the VR space, the control unit 123 generates a video (video data) of the online conference based on the avatar images of the other participants, the CG conference room image, the position orientation information of the other avatars, seat information of the avatars, and position orientation information of the user. When the unreal space is the MR space, the control unit 123 does not receive the CG conference room image and generates the video (video data) of the online conference by using the real image acquired by the image acquisition unit 121 instead of the CG conference room image. Then, the control unit 123 performs control to display the generated video on the display unit 112. For example, the control unit 123 generates a video in which avatar images are superimposed on the CG conference room image or the real image. The control unit 123 controls the orientations of the avatars based on position orientation information and controls the positions of the avatars based on the seat information (information indicating the seats). Note that the generated video is a first-person viewpoint video, and the avatar of the user is not displayed.

The voice acquisition unit 124 acquires the voice (voice data) obtained by the voice input unit 114. The control unit 123 transmits the voice (voice data) obtained by the voice acquisition unit 124 to the server device 200 in order to convey the voice to the other participants. The control unit 123 receives the voice data of the other participant (the voice data obtained by the HMDs (voice input units) of the other participants) from the server device 200. Then, the control unit 123 generates voice (voice data) to be output from the voice output unit 115 based on the received voice data. The voice transmission unit 125 transmits the voice data generated by the control unit 123 to the voice output unit 115, and the voice output unit 115 outputs the voice according to the voice data transmitted from the voice transmission unit 125. As a result, the voice is output from the voice output unit 115 so that the voice of the other participants can be heard from the direction in which the avatars of the other participants are present.

The communication unit 150 is a communication interface that communicates with an external device by wire or wirelessly. The communication method (communication protocol) is not particularly limited, but for example, the communication unit 150 communicates with an external device by a so-called wireless LAN conforming to the IEEE 802.11 standard.

The participant detection unit 160 detects other participants from the surroundings of the user in the real space. For example, the participant detection unit 160 detects the other client devices (client devices of the other participants) by Bluetooth (registered trademark). The detection of other client devices can also be understood as detection of other HMD systems (HMD systems of other participants). The participant detection unit 160 receives a beacon signal emitted from the other HMD systems (the other client devices) when the other participants exist around the user in the real space. Then, the control unit 123 detects identification numbers of the other HMD systems, directions in which the other HMD systems exist, and distances to the other HMD systems from the beacon signals received by the participant detection unit 160. When the plurality of other participants exist around the user in the real space, a plurality of combinations of identification numbers, directions, and distances are detected. Furthermore, the participant detection unit 160 emits beacon signals so that the other HMD systems (participant detection units) can detect the HMD system 100. The control unit 123 transmits the detected information to the server device 200. Note that the method of detecting another participant is not particularly limited, and for example, another HMD system may be detected from the image acquired by the image acquisition unit 121.

The input processing unit 126 acquires the operation signal output from the operation unit 170. The control unit 123 controls the action of the avatar corresponding to the user according to the operation signal acquired by the input processing unit 126. The control unit 123 transmits the operation signal acquired by the input processing unit 126 to the server device 200 in order to share the operation signal with other participants of the online conference. The control unit 123 receives an operation signal of another participant (an operation signal obtained by the input device (operation unit) of the other participant) from the server device 200. Then, the control unit 123 controls the action of the other avatar (the avatar corresponding to the other participant) according to the received operation signal. The control unit 123 may switch the unreal space between the VR space and the MR space according to the operation signal acquired by the input processing unit 126.

### Configuration of Server Device

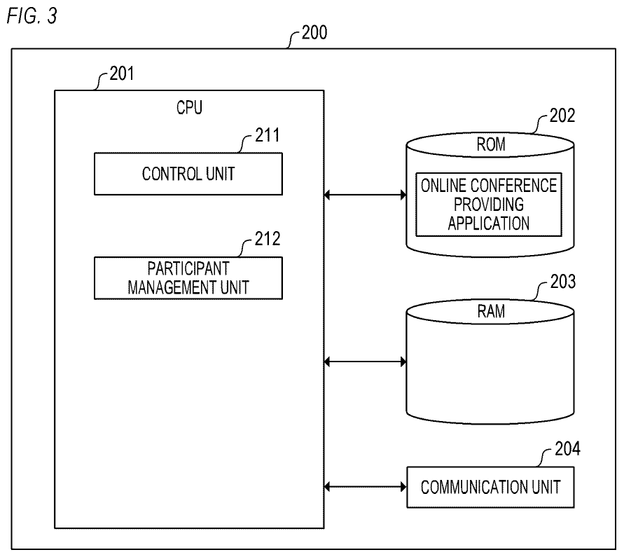

FIG. 3 is a block diagram illustrating a configuration of the server device 200. The server device 200 includes a CPU 201, a ROM 202, a RAM 203, and a communication unit 204. A control unit 211 and a participant management unit 212 are implemented by the CPU 201.

The CPU 201 performs various types of processing (various types of control) of the server device 200. The ROM 202 is a nonvolatile memory. The ROM 202 stores programs of an operating system (OS), programs of various types of applications, and other information. For example, a program of an application (online conference providing application) for providing the online conference service to each HMD system and participant information of the online conference are stored in the ROM 202. The participant information is, for example, a list indicating an identification number of the HMD system for each participant. The RAM 203 is a volatile memory and is used as, for example, a work area of the CPU 201.

The control unit 211 executes an online conference providing application (a program of the online conference providing application) stored in the ROM 202 and executes various types of processing for providing the online conference service to each HMD system. For example, the control unit 211 transmits the avatar images of the other participants and the CG conference room image to each HMD system (each client device). Furthermore, the control unit 211 transmits and receives the position orientation information and the operation information to and from each HMD system (each client device) so that the position orientation information and the operation information of each participant are shared by the plurality of participants. The control unit 211 transmits the seat information of each avatar to each HMD system (each client device). The control unit 211 transmits and receives voice data to and from the HMD system (client device) in order to convey the voice data of the participant to the other participants. For example, the control unit 211 transmits the voice data received from the HMD system 100 to the HMD systems 400, 500, and 600. The control unit 211 controls the communication unit 204 to communicate with each HMD system (each client device).

The participant management unit 212 manages the identification numbers of the HMD systems and the seats on which the avatars sit in the online conference room for each participant of the online conference.

The communication unit 204 is a communication interface that communicates with an external device by wire or wirelessly. The communication method (communication protocol) is not particularly limited, but for example, the communication unit 204 communicates with an external device by a so-called wireless LAN conforming to the IEEE 802.11 standard.

### Seat of Avatar

The participant management unit 212 determines the seats of the avatars in the online conference. The determination of the seat of the avatars in the online conference can also be understood as the determination of the arrangement of the avatars in the unreal space. In the online conference system in the related art, positional relationships of the plurality of participants (the plurality of HMD systems) who are near in the real space may be different from positional relationships of the plurality of avatars (the plurality of avatars respectively corresponding to the plurality of participants) in the unreal space. In this case, the direction in which the voices of the other participants are heard through the speaker of the HMD is different from the direction in which the voices of the other participants are heard without the speaker of the HMD. Therefore, the participants feel uncomfortable and the immersive feeling of the participants is impaired.

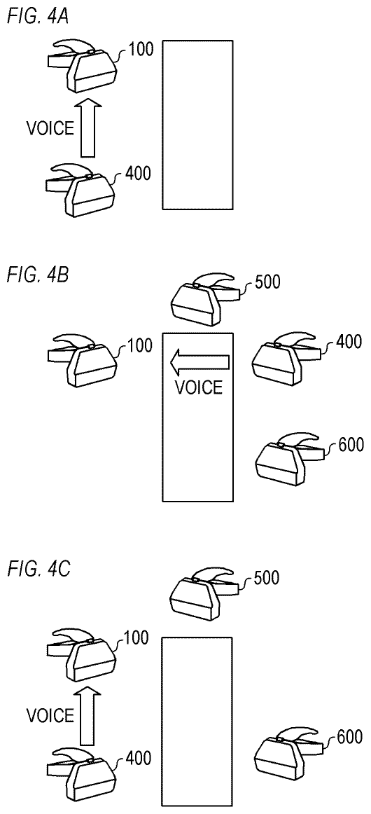

FIG. 4A is a schematic diagram illustrating arrangement of the HMD systems (participants) in the real space. In FIG. 4A, the participant using the HMD system 400 is next to the right of the participant using the HMD system 100. FIG. 4B is a schematic diagram illustrating the arrangement of the avatars in the unreal space. In FIG. 4B, the avatar of the participant using the HMD system 400 is in front of the avatar of the participant using the HMD system 100. At this time, the voice of the participant using the HMD system 400 is heard by the participant using the HMD system 100 from two directions of the right direction and the front direction. The voice of the participant using the HMD system 400 is heard from the right direction without the speaker of the HMD system 100 and is heard from the front direction through the speaker of the HMD system 100.

Therefore, in the first embodiment, as illustrated in FIG. 4C, the avatar of the participant using the HMD system 400 is disposed on the right side (next to the right) of the avatar of the participant using the HMD system 100. That is, for the plurality of participants who are near in the real space, the positional relationship of the plurality of avatars in the unreal space is made to substantially coincide with the positional relationship of the plurality of participants in the real space. In this way, the participant using the HMD system 100 can hear the voice of the participant using the HMD system 400 only from the right direction, and the effect of reducing the uncomfortable feeling and improving the immersive feeling can be obtained.

Furthermore, the positional relationship among the plurality of participants in the real space is not necessarily predetermined. Therefore, in the first embodiment, even when the positional relationship of the plurality of participants in the real space is not predetermined, the arrangement of the avatars in the unreal space can be suitably determined.

### Processing Flow of Online Conference System

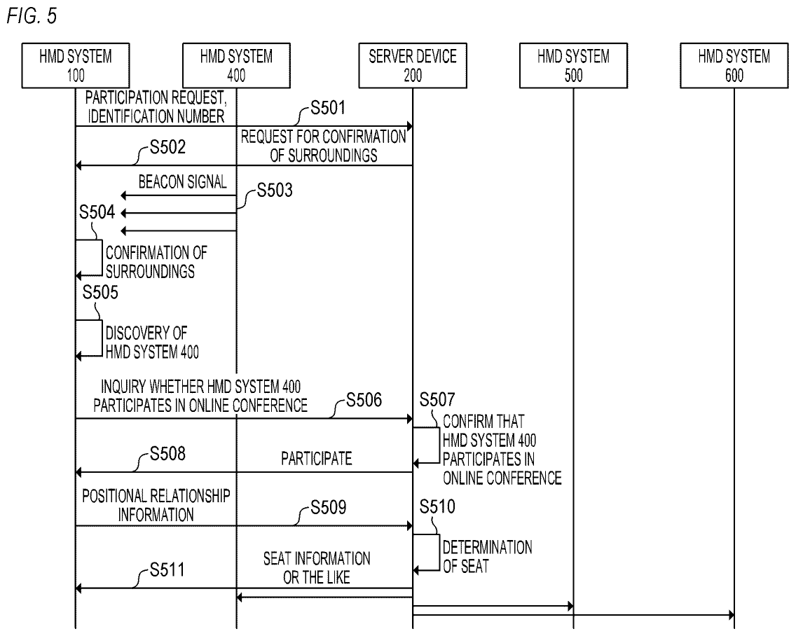

FIG. 5 is a sequence diagram illustrating a processing flow of the system (online conference system) of FIG. 1. FIG. 5 illustrates a processing flow in determining a seat (disposition) of an avatar corresponding to a participant who newly participates in the online conference. Here, it is assumed that the user of the HMD system 100 participates in the online conference.
In step S501, the HMD system 100 transmits a participation request to the online conference and the identification number of the HMD system 100 to the server device 200.
In step S502, the server device 200 transmits a confirmation request as to whether another HMD system (another participant) exists around the HMD system 100 (the user of the HMD system 100) in the real space to the HMD system 100.
In step S503, the HMD system 400 emits a beacon signal to the surroundings. Not limited to the timing of step S503, the HMD system 400 may constantly or periodically emit a beacon signal. Also, the HMD systems 100, 500, and 600 may emit beacon signals.
In step S504, the HMD system 100 confirms (determines) whether another HMD system exists around the HMD system 100 in the real space.

Here, it is assumed that the HMD system 400 (the user of the HMD system 400) exists around the HMD system 100 (the user of the HMD system 100) in the real space. Therefore, in step S505, the HMD system 100 receives the beacon signal of the HMD system 400. As a result, it is detected that the HMD system 400 exists around the HMD system 100 in the real space. Then, the HMD system 100 detects the identification number of the HMD system 400 from the received beacon signal. Further, the HMD system 100 detects, from the received beacon signal, a direction in which the HMD system 400 exists with respect to the HMD system 100 in the real space, and a distance between the HMD system 100 and the HMD system 400 in the real space.
In step S506, the HMD system 100 transmits the identification number of the HMD system 400 to the server device 200. This processing is also processing of inquiring whether the HMD system 400 participates in the online conference (the same online conference as the online conference in which the HMD system 100 participates).
In step S507, the server device 200 confirms (determines) whether the HMD system 400 participates in the online conference (the same online conference as the online conference in which the HMD system 100 participates) from the received identification number of the HMD system 400.

Here, it is assumed that the HMD systems 400, 500, and 600 participate in the online conference. Since the HMD system 400 participates in the online conference, in step S508, the server device 200 notifies the HMD system 100 that the HMD system 400 participates in the online conference.
In step S509, the HMD system 100 generates information (positional relationship information) on the positional relationship between the HMD system 100 and the HMD system 400 in the real space from the direction and the distance detected in step S505. For example, information indicating the relative position of the HMD system 400 with respect to the HMD system 100 is generated. The relative position is indicated by, for example, the direction and the distance detected in step S505. Then, the HMD system 100 transmits the generated positional relationship information to the server device 200. Note that the format of the positional relationship information is not particularly limited, and for example, information indicating the relative position of the HMD system 100 with respect to the HMD system 400 may be generated.
In step S510, the server device 200 determines the seats of the avatars. Here, the seats of the avatars are determined based on the positional relationship information transmitted in step S509 (the positional relationship between the HMD system 100 and the HMD system 400 in the real space). For example, the seats of the avatars are determined so that the direction in which the avatar of the HMD system 400 exists with respect to the avatar of the HMD system 100 in the unreal space substantially coincides with the direction in which the HMD system 400 exists with respect to the HMD system 100 in the real space. As a result, the latest seat information of the avatars can be obtained.
In step S511, the server device 200 transmits necessary information to the HMD systems 100, 400, 500, and 600. For example, avatar images, CG conference room images, and the latest seat information of the HMD systems 400, 500, and 600 are transmitted to the HMD system 100. The avatar image and the latest seat information of the HMD system 100 are transmitted to the HMD systems 400, 500, and 600. As a result, the online conference by the HMD systems 100, 400, 500, and 600 is started. Then, the position orientation information, the operation information, and the voice data are transmitted and received as necessary. Note that a method of registering the avatar is not particularly limited, but it is assumed that the avatars of the HMD systems 100, 400, 500, and 600 are registered in the server device 200 in advance.

Note that, when no other HMD system exists around the HMD system 100 in the real space, the processing of steps S505 to S509 is omitted. The HMD system 100 transmits, to the server device 200, that no other HMD system exists around the HMD system 100 in the real space. Then, in step S510, the server device 200 determines the seats of the avatars not based on the positional relationship information.

Furthermore, when the HMD system 400 does not participate in the online conference, the processing of steps S508 and S509 is omitted. The server device 200 notifies the HMD system 100 that the HMD system 400 is not participating in the online conference. Then, in step S510, the server device 200 determines the seats of the avatars not based on the positional relationship information.

### Processing Flow of HMD System

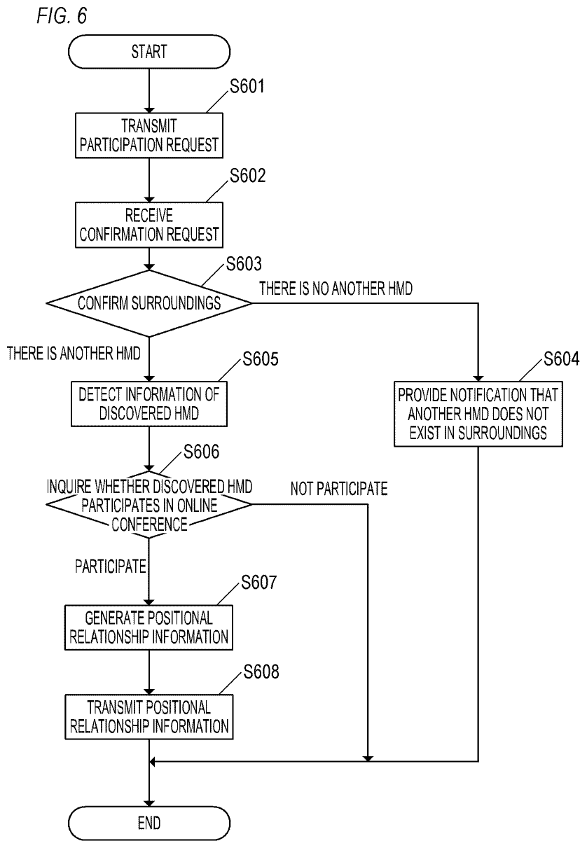

FIG. 6 is a flowchart illustrating a processing flow of the HMD system 100. FIG. 6 illustrates a processing flow when the HMD system 100 newly participates in the online conference.
In step S601, the control unit 123 controls the communication unit 150 to transmit the request for participation of the online conference and the identification number of the HMD system 100 to the server device 200.
In step S602, the control unit 123 controls the communication unit 150 to receive a confirmation request as to whether another HMD system exists around the HMD system 100 in the real space from the server device 200.
In step S603, the control unit 123 controls the participant detection unit 160 to confirm whether another HMD system exists around the HMD system 100 in the real space. When the participant detection unit 160 receives the beacon signal (when it is detected that another HMD system exists around the HMD system 100 in the real space), the processing proceeds to step S605. When the participant detection unit 160 does not receive the beacon signal (when it is detected that another HMD system does not exist around the HMD system 100 in the real space), the processing proceeds to step S604.
In step S604, the control unit 123 notifies the server device 200 that another HMD system does not exist around the HMD system 100 in the real space by controlling the communication unit 150.
In step S605, the control unit 123 detects the identification number of the discovered HMD system, the direction in which the discovered HMD system exists, and the distance to the discovered HMD system from the beacon signal received in step S603.
In step S606, the control unit 123 controls the communication unit 150 to transmit the identification number detected in step S605 (identification number of the discovered HMD system) to the server device 200. This processing is also processing of inquiring whether the discovered HMD system participates in the online conference (the same online conference as the online conference in which the HMD system 100 participates). When there is a response indicating that the discovered HMD system participates in the online conference in response to the inquiry, the processing proceeds to step S607. When there is a response indicating that the discovered HMD system does not participate in the online conference in response to the inquiry, the processing of FIG. 6 ends.
In step S607, the control unit 123 generates information (positional relationship information) on the positional relationship between the HMD system 100 and the discovered HMD system in the real space from the direction and distance detected in step S605.
In step S608, the control unit 123 transmits the positional relationship information generated in step S607 to the server device 200.

### Processing Flow of Server Device

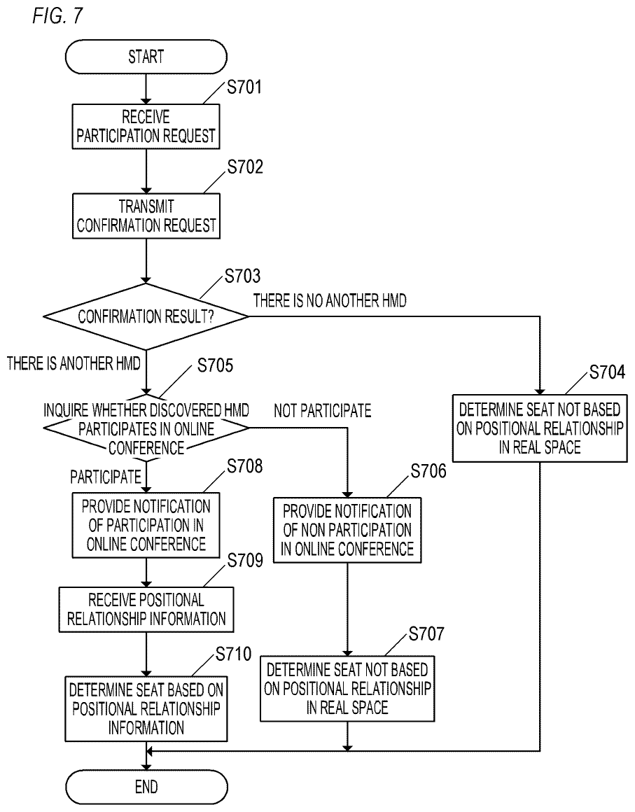

FIG. 7 is a flowchart illustrating a processing flow of the server device 200. FIG. 7 illustrates a processing flow in determining a seat of an avatar corresponding to a participant who newly participates in the online conference. It is assumed that the user of the HMD system 100 participates in the online conference.
In step S701, the control unit 211 controls the communication unit 204 to receive the request for participation of the online conference and the identification number of the HMD system 100 from the HMD system 100.
In step S702, the control unit 211 controls the communication unit 204 to transmit a confirmation request as to whether another HMD system exists around the HMD system 100 in the real space to the HMD system 100.
In step S703, the control unit 211 controls the communication unit 204 to receive a response to the confirmation request in step S701 from the HMD system 100. Then, the control unit 211 confirms (determines) whether another HMD system exists around the HMD system 100 in the real space from the response to the confirmation request. When another HMD system is discovered (detected) from the surroundings of the HMD system 100 in the real space, the identification number of the discovered HMD system is received as a response to the confirmation request. When another HMD system is not discovered around the HMD system 100 in the real space, information indicating that another HMD system does not exist around the HMD system 100 in the real space is received as a response to the confirmation request. The processing proceeds to step S705 when the HMD system is discovered, and the processing proceeds to step S704 when the HMD system is not discovered.
In step S704, the control unit 211 determines the seats of the avatars not based on the positional relationship among the plurality of HMD systems in the real space.
In step S705, the control unit 211 controls the participant management unit 212 to confirm (determine) whether the HMD system discovered by the HMD system 100 participates in the online conference from the identification number received in step S703. Here, the online conference means an online conference in which the HMD system 100 participates. The processing proceeds to step S708 when the discovered HMD system participates in the online conference, and the processing proceeds to step S706 when the discovered HMD system does not participate in the online conference.
In step S706, the control unit 211 controls the communication unit 204 to notify the HMD system 100 that the HMD system discovered by the HMD system 100 does not participate in the online conference.
In step S707, the control unit 211 determines the seats of the avatars not based on the positional relationship among the plurality of HMD systems in the real space.
In step S708, the control unit 211 controls the communication unit 204 to notify the HMD system 100 that the HMD system discovered by the HMD system 100 participates in the online conference.
In step S709, the control unit 211 controls the communication unit 204 to receive information (positional relationship information) on the positional relationship between the HMD system 100 and the discovered HMD system in the real space from the HMD system 100.
In step S710, the control unit 211 determines the seats of the avatars based on the positional relationship information received in step S709.

As described above, according to the first embodiment, when it is detected that another participant exists around the new participant in the real space, the information on the positional relationship of the participants in the real space is acquired, and the arrangement of the avatars is determined based on the information. As a result, in the service that enables communication in the unreal space, even when the positional relationship of the plurality of participants in the real space is not predetermined, the arrangement of the avatars in the unreal space can be suitably determined.

Note that the example in which the HMD system 100 confirms whether another HMD system exists around the HMD system 100 in the real space in response to the confirmation request transmitted from the server device 200 is described, but the present invention is not limited thereto. For example, the server device 200 may not transmit the confirmation request to the HMD system 100. Then, the HMD system 100 may constantly or periodically confirm whether another HMD system exists around the HMD system 100 in the real space.

Furthermore, the example in which the HMD system 100 inquires of the server device 200 whether the discovered HMD system participates in the online conference is described, but the present invention is not limited thereto. For example, when another HMD system is discovered, the HMD system 100 may transmit the positional relationship information to the server device 200 without making an inquiry. If the discovered HMD system participates in the online conference, the server device 200 determines the seats of the avatars based on the positional relationship information. If the discovered HMD system does not participate in the online conference, the server device 200 determines the seats of the avatars not based on the positional relationship information.

Furthermore, the HMD system 100 (the client device 102) may have the function of the server device 200 and provide the online conference service to another HMD system.

Furthermore, an example in which a new participant (the HMD system 100) searches for another participant (another HMD system) from the surroundings of the new participant in the real space is described, but the present invention is not limited thereto. For example, an existing participant (the HMD systems 400, 500, and 600) may be notified that a new participant is added, and the existing participant may search for other participants from around the participant in the real space.

### Second Embodiment

A second embodiment of the present invention is now described. Note that, in the following description, the same description as in the first embodiment (for example, the description about the same configuration and processing as in the first embodiment) is omitted, and the difference from the first embodiment is described.

In the online conference, a participant may instruct the avatar to move. When the avatar can move anywhere, for a plurality of participants who are near in the real space, the positional relationship of the plurality of avatars in the unreal space may deviate from the positional relationship of the plurality of participants in the real space. Then, when the positional relationship is deviated, the direction in which the voices of the other participants are heard via the speaker of the HMD is different from the direction in which the voices of the other participants are heard without the speaker of the HMD. Therefore, the participants feel uncomfortable and the immersive feeling of the participants is impaired. Therefore, in the second embodiment, the movement of the avatar is restricted based on the positional relationship information, and predetermined notification is given to the participant who gives instruction of the movement.

### Restriction on Seat Change

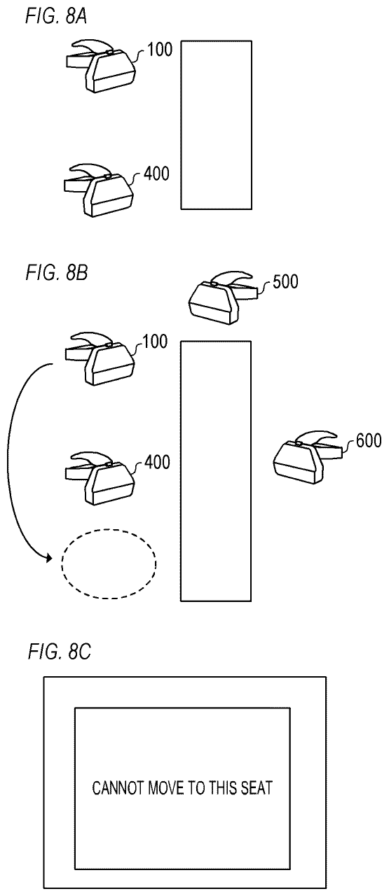

FIG. 8A is a schematic diagram illustrating arrangement of the HMD systems (participants) in the real space. The participant using the HMD system 100 is next to the left of the participant using the HMD system 400. FIG. 8B is a schematic diagram illustrating the arrangement of the avatars in the unreal space. The avatar of the participant using the HMD system 100 is next to the left of the avatar of the participant using the HMD system 400. That is, the positional relationship of the HMD systems 100 and 400 (avatars) in the unreal space is identical to the positional relationship of the HMD systems 100 and 400 (participants) in the real space. From this situation, it is assumed that the participant using the HMD system 100 gives instruction to move the avatar of the participant to next to the right of the avatar of the participant using the HMD system 400. When such movement is permitted, the positional relationship of the HMD systems 100 and 400 (avatars) in the unreal space does not identical to (substantially not coincide with) the positional relationship of the HMD systems 100 and 400 (participants) in the real space. In the first embodiment, predetermined notification (for example, a notification that the avatar cannot be moved to a designated position (seat)) is given to the participant who gives instruction of the movement without following such instruction of the movement. For example, the warning screen of FIG. 8C is displayed on the display unit 112 of the HMD system 100.

### Processing Flow of Online Conference System

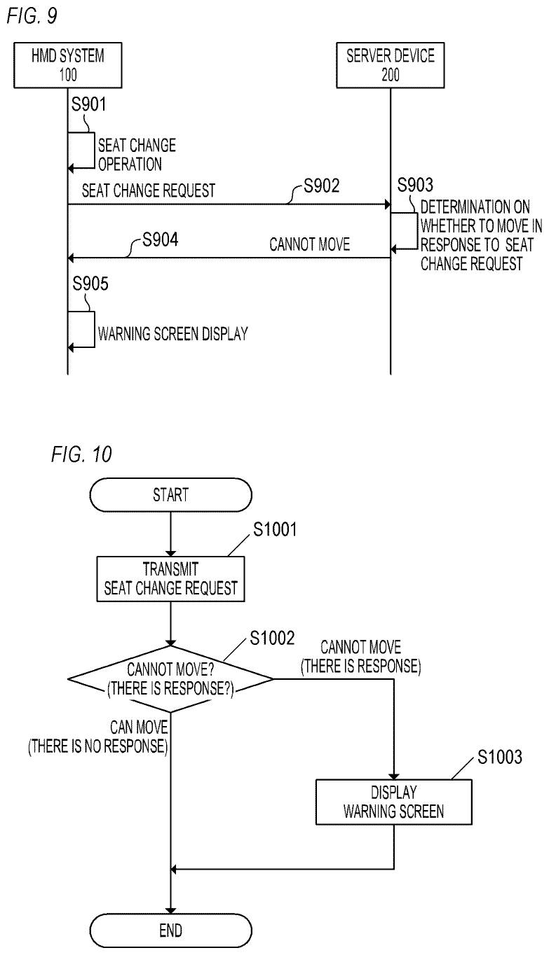

FIG. 9 is a sequence diagram illustrating a processing flow of the online conference system according to the second embodiment. FIG. 9 illustrates a processing flow when the instruction of the movement of the avatar is given during the online conference, but the instruction of the movement is not received, and the predetermined notification is performed. Here, it is assumed that the user of the HMD system 100 gives instruction of the movement of the avatar of the user.
In step S901, the HMD system 100 receives instruction to move the avatar of the HMD system 100 (seat change operation on the operation unit 170) from the user of the HMD system 100.
In step S902, the HMD system 100 transmits a seat change request to the server device 200. The seat change request includes information on a seat change operation. For example, the seat change request indicates a position after movement designated by the user of the HMD system 100.
In step S903, the server device 200 determines whether to move the avatar in accordance with the seat change request in step S902 (the seat change operation in step S901) based on the positional relationship information related to the HMD system 100. The server device 200 confirms (determines) whether the above-described inconsistency (inconsistency between the positional relationship in the real space and the positional relationship in the unreal space) occurs due to the movement of the avatar to the designated position. Then, the server device 200 determines to move the avatar when there is no inconsistency and determines not to move the avatar when there is inconsistency. When the positional relationship information on the HMD system 100 is not acquired in advance, another HMD system does not exist around the HMD system 100 in the real space, and thus, the server device 200 determines to move the avatars.

For example, it is assumed that the HMD system 400 exists around the HMD system 100 in the real space. A direction in which the avatar of the HMD system 400 exists with respect to the avatar of the HMD system 100 in the unreal space is defined as a first direction, and a direction in which the HMD system 400 exists with respect to the HMD system 100 in the real space is defined as a second direction. The server device 200 confirms (determines) whether the first direction substantially coincides with the second direction even if the avatar is moved in accordance with the seat change request. Then, the server device 200 determines to move the avatar when the first direction substantially coincides with the second direction and determines not to move the avatar when the first direction substantially does not coincide with the second direction.

Here, it is assumed that it is determined that the avatar is not moved. Therefore, in step S904, the server device 200 notifies the HMD system 100 that the avatar cannot be moved. When it is determined that the avatar is moved, the server device 200 moves the avatar in accordance with the seat change request without notifying the HMD system 100. When the seat information is updated in accordance with the movement of the avatar, the server device 200 transmits the latest seat information to each HMD system.
In step S905, the HMD system 100 displays, on the display unit 112, a warning screen indicating that the avatar cannot be moved to the designated position.

### Processing Flow of HMD System

FIG. 10 is a flowchart illustrating a processing flow of the HMD system 100. FIG. 10 illustrates a processing flow when a seat change operation is performed on the HMD system 100.

When the seat change operation is performed on the HMD system 100, the control unit 123 transmits the seat change request to the server device 200 by controlling the communication unit 150 in step S1001.
In step S1002, the control unit 123 confirms (determines) whether a response to the seat change request (notification that the avatar cannot be moved) is received. When a response to the seat change request is received, the processing proceeds to step S1003, and the processing of FIG. 10 ends when a response to the seat change request is not received.
In step S1003, the control unit 123 displays, on the display unit 112, a warning screen indicating that the avatar cannot be moved to the designated position.

### Processing Flow of Server Device

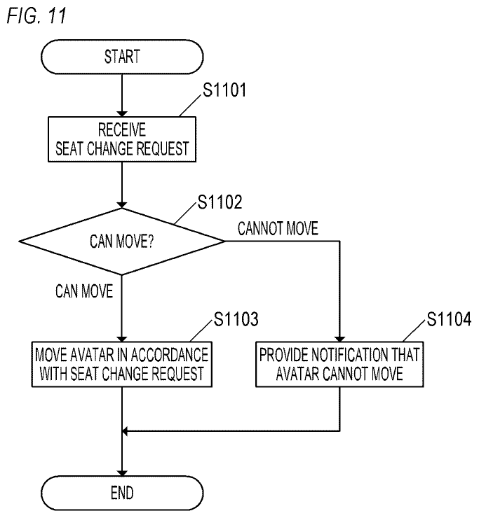

FIG. 11 is a flowchart illustrating a processing flow of the server device 200. FIG. 11 illustrates a processing flow when a seat change operation is performed on the HMD system 100. Note that it is assumed that the positional relationship information on the HMD system 100 is acquired in advance.

When the seat change operation is performed on the HMD system 100, the control unit 211 receives the seat change request from the HMD system 100 by controlling the communication unit 204 in step S1101.
In step S1102, the control unit 211 determines whether to move the avatar in accordance with the seat change request (seat change operation) in step S1101. This processing corresponds to step S903. The processing proceeds to step S1103 when the avatar is moved, and the processing proceeds to step S1104 when the avatar is not moved.
In step S1103, the control unit 211 moves the avatar in accordance with the seat change request in step S1101.
In step S1104, the control unit 211 controls the communication unit 204 to notify the HMD system 100 that the avatar cannot be moved.

As described above, according to the second embodiment, the movement of the avatar is restricted, and the predetermined notification is made to the participant who gives instruction of the movement. By restricting the movement of the avatar, for a plurality of participants who are near in the real space, it is possible to prevent inconsistency between the positional relationship of the plurality of avatars in the unreal space and the positional relationship of the plurality of participants in the real space. Then, by performing the predetermined notification, it is possible to prevent generation of uncomfortable feeling and discomfort caused by restriction of the movement of the avatar.

Note that, the example of restricting the movement of the avatar is described, but it is possible to perform predetermined notification (for example, notification that the presence feeling or the immersive feeling is reduced) to the participant who gives the instruction of movement without limiting the movement of the avatar. In this way, a situation in which the participant (avatar) cannot approach another close participant (another avatar) does not occur. In addition, the participants can participate in the online conference from a preferred viewpoint. For the plurality of participants who are near in the real space, a participant who wants to match the positional relationship of the plurality of avatars in the unreal space with the positional relationship of the plurality of participants in the real space can be prompted to cancel the movement of the avatar.

### Third Embodiment

A third embodiment of the present invention is described. Note that, in the following description, the same description as in the first embodiment (for example, the description about the same configuration and processing as in the first embodiment) is omitted, and the difference from the first embodiment is described.

When the unreal space is the VR space, an avatar is displayed in the HMD system of the participant as another participant who is near the participant in the real space. In this case, for the plurality of participants who are near in the real space, even when the positional relationship of the plurality of avatars in the unreal space is slightly different from the positional relationship of the plurality of participants in the real space, an uncomfortable feeling is little. For example, if the direction in which the plurality of avatars are arranged in the unreal space substantially coincides with the direction in which the plurality of participants are arranged in the real space, an uncomfortable feeling is little.

When the unreal space is the MR space, the avatars of other participants who are near the participant in the real space are not displayed in the HMD system of the participant. In the case of the optical see-through method, the participant can directly view other participants near the participant. In the case of the video see-through method, a real image (image obtained by capturing the real space) obtained by capturing a range including other participants near the participant is displayed in the HMD system of the participant. Therefore, the participant can see other participants near the participant in the real space in the real image. In this case, if the above-described two positional relationships (the positional relationship in the real space and the positional relationship in the unreal space) are different, the avatar of the participant in the remote location may be superimposed to the other participant near the participant in the real space.

Therefore, in the third embodiment, the method of determining arrangement of the avatars is made different between the case where the unreal space is the VR space and the case where the unreal space is the MR space. For example, when the unreal space is the VR space, the arrangement of the avatars is determined based on the direction in which the plurality of participants who are near in the real space are arranged. Then, when the unreal space is the MR space, the seats (arrangement) of the avatars are determined based on the direction in which the plurality of participants who are near in the real space are arranged and the distance (interval) between the plurality of participants.

### Seat of Avatar

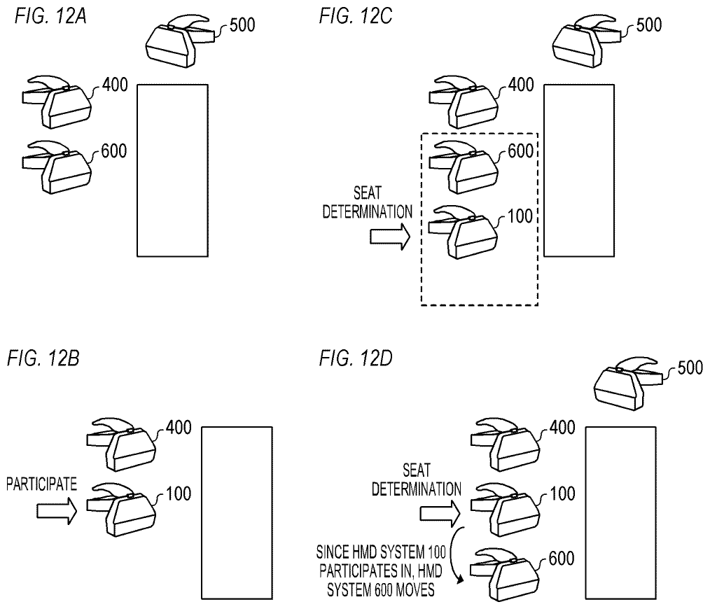

FIG. 12A is a schematic diagram illustrating the arrangement of the avatars in the unreal space. In FIG. 12A, the users of the HMD systems 400, 500, and 600 participate in the online conference.

FIG. 12B is a schematic diagram illustrating arrangement of the HMD systems in the real space. In FIG. 12B, the user of the HMD system 100 is next to the right of the user of the HMD system 400. This indicates that a user using the HMD system 100 tries to participate in the online conference.

FIG. 12C is a schematic diagram illustrating the arrangement of the avatars in the unreal space. It is assumed that the unreal space is the VR space, and the user of the HMD system 100 tries to participate in the online conference in the situations of FIGS. 12A and 12B. In this case, the seat of the avatar of the HMD system 100 may be determined based on the direction (right direction) in which the HMD system 100 (the user of the HMD system 100) exists with respect to the HMD system 400 (user of the HMD system 400) in the real space. Therefore, the avatar of the HMD system 100 is disposed on the right side of the avatar of the HMD system 400. For example, the avatar of the HMD system 100 is disposed within the range enclosed by the dashed lines in FIG. 12C. In the example of FIG. 12C, the avatar of the HMD system 100 is disposed at an unoccupied seat, avoiding the avatar seat of the HMD system 600.

FIG. 12D is a schematic diagram illustrating the arrangement of the avatars in the unreal space. It is assumed that the unreal space is the MR space, and the user of the HMD system 100 tries to participate in the online conference in the situations of FIGS. 12A and 12B. In this case, the seat of the avatar of the HMD system 100 may be determined based on the direction in which the HMD system 100 exists with respect to the HMD system 400 in the real space, and the distance between the HMD system 400 and the HMD system 100 in the real space. Therefore, the avatar of the HMD system 100 is disposed next to the right of the avatar of the HMD system 400. Also, the avatar of the HMD system 600 next to the right of the avatar of the HMD system 400 is moved to another seat.

### Processing Flow of Server Device

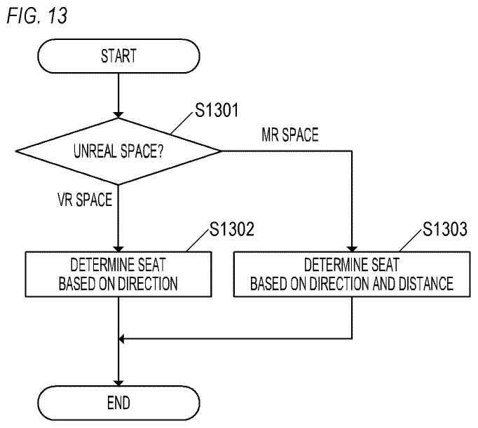

FIG. 13 is a flowchart illustrating a processing flow of the server device 200. Here, it is assumed that the processing of FIG. 13 is performed in step S710 of FIG. 7. It is assumed that the users of the HMD systems 400, 500, and 600 participate in the online conference, and the user of the HMD system 100 newly participates in the online conference. Then, it is assumed that the HMD system 400 (the user of the HMD system 400) exists around the HMD system 100 (the user of the HMD system 100) in the real space.
In step S1301, the control unit 211 confirms (determines) whether the unreal space is the VR space or the MR space. The processing proceeds to step S1302 when the unreal space is the VR space, and the processing proceeds to step S1303 when the unreal space is the MR space.
In step S1302, the control unit 211 determines the seats of the avatars based on the direction in which the HMD system 100 exists with respect to the HMD system 400 in the real space. For example, the arrangement of the avatars is determined so that the direction in which the avatar of the HMD system 100 exists with respect to the avatar of the HMD system 400 in the unreal space substantially coincides with the direction in which the HMD system 100 exists with respect to the HMD system 400 in the real space.

In step S1303, the control unit 211 determines the seats of each avatars based on the direction in which the HMD system 100 exists with respect to the HMD system 400 in the real space and the distance between the HMD system 400 and the HMD system 100 in the real space. For example, a direction in which the avatar of the HMD system 100 exists with respect to the avatar of the HMD system 400 in the unreal space is defined as a first direction, and a direction in which the HMD system 100 exists with respect to the HMD system 400 in the real space is defined as a second direction. A distance between the avatar of the HMD system 400 and the avatar of the HMD system 100 in the unreal space is defined as a first distance, and a distance between the HMD system 400 and the HMD system 100 in the real space is defined as a second distance. Then, the arrangement of the avatars is then determined so that the first direction substantially coincides with the second direction, and the first distance substantially coincides with the second distance.

As described above, according to the third embodiment, the method of determining the arrangement of the avatars is switched so that the arrangement of the avatars is determined in different manners in the case where the unreal space is the VR space and the case where the unreal space is the MR space. As a result, in each of the case of the VR space and the MR space, the arrangement of the avatars can be more suitably determined.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, in the service that enables communication in the unreal space, even when the positional relationship of the plurality of participants in the real space is not predetermined, the arrangement of the avatars in the unreal space can be suitably determined.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising one or more processors and/or circuitry configured to:
execute determination processing of determining arrangement of a plurality of avatars in an unreal space respectively corresponding to a plurality of participants of a service that enables communication in the unreal space;
execute acquisition processing of acquiring information on a positional relationship of a first participant and a second participant in a real space in a case where it is detected that the second participant in the service exists near the first participant who newly participates in the service, in the real space; and
execute control processing of performing control to perform predetermined notification to the first participant based on the information in a case where the first participant gives instruction of movement of the avatar of the first participant, wherein,
in the determination processing, arrangement of the plurality of avatars is determined based on the information.

2. The information processing apparatus according to claim 1, wherein
the information processing apparatus is a server device to which a plurality of client devices respectively used by the plurality of participants are connected.

3. The information processing apparatus according to claim 1, wherein
the information processing apparatus is an information processing apparatus used by any of the plurality of participants.

4. The information processing apparatus according to claim 3, wherein
the one or more processors and/or circuitry further execute detection processing of detecting another participant in the service from surroundings of the participant who uses the information processing apparatus in the real space.

5. The information processing apparatus according to claim 1, wherein,
in the determination processing, the arrangement of the plurality of avatars is determined so that a direction in which the avatar of the second participant exists with respect to the avatar of the first participant in the unreal space substantially coincides with a direction in which the second participant exists with respect to the first participant in the real space.

6. The information processing apparatus according to claim 1, wherein
in the determination processing, arrangement of the plurality of avatars is determined so that a first direction in which the avatar of the second participant exists with respect to the avatar of the first participant in the unreal space substantially coincides with a second direction in which the second participant exists with respect to the first participant in the real space, and
in the control processing, in a case where the first direction does not substantially coincide with the second direction by moving the avatar of the first participant according to the instruction of the first participant, control is performed to perform the predetermined notification to the first participant.

7. The information processing apparatus according to claim 1, wherein
the unreal space is a virtual reality space or a mixed reality space.

8. The information processing apparatus according to claim 7, wherein
in the determination processing, the arrangement of the plurality of avatars is determined so that a method of determining arrangement of the plurality of avatars is different between a case where the unreal space is the virtual reality space and a case where the unreal space is the mixed reality space.

9. The information processing apparatus according to claim 8, wherein
in the determination processing,
in a case where the unreal space is the virtual reality space, the arrangement of the plurality of avatars is determined based on a direction in which the second participant exists with respect to the first participant in the real space, and
in a case where the unreal space is the mixed reality space, the arrangement of the plurality of avatars is determined based on a direction in which the second participant exists with respect to the first participant in the real space and a distance between the first participant and the second participant in the real space.

10. The information processing apparatus according to claim 9, wherein
in the determination processing,
in a case where the unreal space is the virtual reality space, the arrangement of the plurality of avatars is determined so that a first direction in which the avatar of the second participant exists with respect to the avatar of the first participant in the unreal space substantially coincides with a second direction in which the second participant exists with respect to the first participant in the real space; and
in a case where the unreal space is the mixed reality space, the arrangement of the plurality of avatars is determined so that the first direction substantially coincides with the second direction, and a distance between the avatar of the first participant and the avatar of the second participant in the unreal space substantially coincides with a distance between the first participant and the second participant in the real space.

11. An information processing method comprising:
determining arrangement of a plurality of avatars in an unreal space respectively corresponding to a plurality of participants of a service that enables communication in the unreal space;
acquiring information on a positional relationship of a first participant and a second participant in a real space in a case where it is detected that the second participant in the service exists near the first participant who newly participates in the service, in the real space; and
performing control to perform predetermined notification to the first participant based on the information in a case where the first participant gives instruction of movement of the avatar of the first participant, wherein
arrangement of the plurality of avatars is determined based on the information.

12. A non-transitory computer readable medium that stores a program, wherein the program causes a computer to execute an information processing method comprising:
determining arrangement of a plurality of avatars in an unreal space respectively corresponding to a plurality of participants of a service that enables communication in the unreal space;
acquiring information on a positional relationship of a first participant and a second participant in a real space in a case where it is detected that the second participant in the service exists near the first participant who newly participates in the service, in the real space; and
performing control to perform predetermined notification to the first participant based on the information in a case where the first participant gives instruction of movement of the avatar of the first participant, wherein
arrangement of the plurality of avatars is determined based on the information.
